(19) United States
(12) Patent Application Publication
(10) Pub. No.: US 2011/0154062 A1
(43) Pub. Date: Jun. 23, 2011

(54) PROTECTION OF ELECTRONIC SYSTEMS FROM UNAUTHORIZED ACCESS AND HARDWARE PIRACY

(76) Inventors: David J. WHELIHAN, Framingham, MA (US); Paul BRADLEY, Cumberland, RI (US); Kumar DWARAKANATH, Framingham, MA (US)

(21) Appl. No.: 12/903,965

(22) Filed: Oct. 13, 2010

Related U.S. Application Data
(60) Provisional application No. 61/251,252, filed on Oct. 13, 2009.

(51) Int. Cl. G06F 12/14

(52) U.S. Cl. 713/193; 713/189

(57) ABSTRACT

A method of designing an electronic system is provided to protect the electronic system from unauthorized access and hardware piracy. The method includes describing the electronic system in a first design and replacing a portion of the electronic system with a reconfigurable module to generate a second design. The reconfigurable module includes a reconfigurable logic block and a configuration block for storing configuration data. The method also includes encrypting configuration data and saving the encrypted configuration data separately from the reconfigurable module. The reconfigurable logic block is configured to correspond to the portion of the electronic system in the first design when the configuration data is loaded in the configuration block.

### CROSS-REFERENCE TO RELATED APPLICATIONS

This application claims priority to provisional U.S. patent application No. 61/251,252 filed Oct. 13, 2009. The content of the aforementioned application is hereby incorporated herein by reference.

### BACKGROUND

This application relates to an electronic system that can be protected from unauthorized access and hardware piracy. This application also relates to a method and an apparatus for designing an electronic system that can be protected from unauthorized access and hardware piracy.

Electronic systems, which include hardware and/or software components, may be implemented on one or more monolithic devices that realize processing or control functions. The monolithic devices are referred to as “chips.” These chips may include processors, Programmable Logic Devices (PLDs), Application Specific Integrated Circuits (ASICs), Application Specific Standard Products (ASSPs) and other off-the-shelf (OTS) components. Examples of the PLDs are Field Programmable Gate Array (FPGA), Complex Programmable Logic Device (CPLD), and Programmable Array Logic (PAL).

The chips may be designed and sent to semiconductor foundries for fabrication. The fabricated chips are assembled with other components and deployed to a target product. During these processes, individuals or organizations may have unauthorized access to “soft” or “hard” intellectual property (IP) of the chips. The soft IP is represented by computer code, such as hardware description language, to describe abstract behavior or structure of the chips. This code is used to synthesize a real or hard IP of the chips. The individuals or organizations may include, but not limited to, chip foundries, integrated device manufacturers, contract manufacturers, parts distributors, and system integrators.

System designers may put safeguards into place to attempt to protect their designs from unauthorized access. However, a motivated attacker can often discover these safeguards and disable them via software or hardware manipulation. Unauthorized access may result in hardware piracy. Hardware piracy is the process of taking a piece of hardware, and using it in ways that it was not intended or replicating the systems or chips and selling them as “genuine” articles. For example, the chips may be pulled from their original circuit board and reused in different systems. The hardware piracy is dangerous for a number of reasons including a safety reason. That is, the reused chips may not be what a system integrator expects, and may therefore fail at critical times.

In order to counter the unauthorized access and hardware piracy, the original chip or system design may be modified with a locking system prior to fabrication. For example, there is a technique of inserting XNOR and XOR gates into a netlist to prevent piracy. This scheme, however, is vulnerable to reverse engineering if the netlist is compromised, as it is reasonably easy to identify the XNOR and XOR gates and the configuration logic that ties them all together. By writing a “chain walker” program, all interconnected XNOR and XOR insertions can be identified and subsequently removed, returning the logic to its original and unprotected state.

As such, the conventional safeguards do not address a fundamental aspect of the unauthorized access and hardware piracy problem. If an adversary can unlock the design, any number of counterfeit parts can be used in ways not intended by the original designer. Therefore, more efficient safeguards are needed to protect electronic systems from unauthorized access and hardware piracy.

### BRIEF SUMMARY

An exemplary embodiment provides efficient safeguards for protecting electronic systems from unauthorized access and hardware piracy. The exemplary embodiment may replace selected logic of a design with reconfigurable hardware so that the design cannot be easily reverse-engineered. The reconfigurable hardware is configured by configuration data that is separately saved and loaded at system run-time. The exemplary embodiment uses an encrypted configuration data to prevent an attacker from deriving the portion of the design that is realized in the reconfigurable hardware. The bits of the configuration data may be randomly permuted to make reverse engineering more difficult.

In one aspect, a method of designing an electronic system is provided to protect the electronic system from unauthorized access and hardware piracy. The method includes describing the electronic system in a first design and replacing a portion of the electronic system with a reconfigurable module to generate a second design. The reconfigurable module includes a reconfigurable logic block and a configuration block for storing configuration data. The method also includes encrypting configuration data and saving the encrypted configuration data separately from the reconfigurable module. The reconfigurable logic block is configured to correspond to the portion of the electronic system in the first design when the configuration data is loaded in the configuration block.

In another aspect, an electronic system is provided that is protected from unauthorized access and hardware piracy. The electronic system includes a reconfigurable module including a reconfigurable logic block and a configuration block for storing configuration data. The reconfigurable logic block is configured to correspond to a portion of the electronic system when the configuration data is loaded in the configuration block. The electronic system also includes a memory device saving the configuration data separately from the reconfigurable module. The configuration data is encrypted and saved in the memory device.

In still another aspect, an apparatus is provided for designing an electronic system protected from unauthorized access and hardware piracy. The apparatus includes a storage device storing a first design of the electronic system. The apparatus also includes a processor configured to replace a portion of the electronic system with a reconfigurable module to generate a second design. The reconfigurable module includes a reconfigurable logic block and a configuration block for storing configuration data. The processor is also configured to encrypt configuration data and save the encrypted configuration data separately from the reconfigurable module. The reconfigurable logic block is configured to correspond to the portion of the electronic system in the first design when the configuration data is loaded in the configuration block.

### BRIEF DESCRIPTION OF THE DRAWINGS

The above and other aspects, features and other advantages will be more clearly understood from the following detailed description taken in conjunction with the accompanying drawings, in which:

FIG. 1 is a computing device suitable for practicing an exemplary embodiment;

FIG. 2 is a flow chart showing steps for designing electronic systems in an exemplary embodiment;

FIG. 3A shows an exemplary logic design of an electronic system including primitive Boolean functions;

FIG. 3B shows an exemplary logic design where elements are replaced with reconfigurable substitution modules (RSMs);

FIG. 4 is an exemplary RSM used in the logic design shown in FIG. 3B;

FIG. 5 is another exemplary RSM with an inserted permutation block;

FIG. 6 is a flowchart describing an exemplary replacement process when the replacement is carried out in Register-Transfer Level (RTL) code;

FIG. 7 is a flowchart describing another exemplary replacement process when the replacement is carried out in a structural netlist;

FIG. 8 is an example of a chip with interconnected RSMs implemented in an exemplary embodiment;

FIG. 9 is an obfuscated, order-dependent access mechanism implemented in an exemplary embodiment; and

FIGS. 10A and 10B show an exemplary embodiment for using the RSM to fix a logic error after fabrication.

### DETAILED DESCRIPTION

An exemplary embodiment provides an efficient method and apparatus for preventing electronic systems from unauthorized access and hardware piracy. In the exemplary embodiment, a system designer may design an electronic system and replace a part of the design with reconfigurable hardware that can be programmed with an encrypted configuration. The exemplary embodiment addresses the data-theft problem by encoding key elements of the design inside reconfigurable hardware. The reconfigurable hardware can emulate a number of functions depending on its configurations, and only one of the configurations is proper for the design. Therefore, the exemplary embodiment not only can protect against information theft, it can also prevent unauthorized access and use, as the chip output can be matched only when a corresponding encrypted configuration is loaded.

An exemplary embodiment may assign a unique key to the reconfigurable hardware so that the reconfigurable hardware cannot be used without a configuration encrypted with the key. Therefore, an electronic system may include reconfigurable hardware and a matched configuration that is loaded when the system is powered on. As such, the exemplary embodiment may provide a powerful barrier to piracy, as the encrypted configurations serve as a valid and inextricably linked fingerprint for both the device and its functionality. The combination of encrypted configuration and logic replacement with reconfigurable hardware creates an efficient defense against Intellectual Property (IP) theft and unauthorized use. Even if a netlist is compromised and even if the replaced logic structures are identified, the original logic function cannot be gleaned from the netlist or logic structures.

The exemplary embodiment is applicable to Application Specific Integrated Circuit (ASIC) chips as it is implemented on Programmable Logic Devices (PLDs). The PLD system is difficult to protect because of the relative ease with which the configurations of the devices can be stolen and subsequently reused. In the exemplary embodiment, however, configuration data or information is separately stored and used to configure the reconfigurable hardware at system run-time. Moreover, each PLD system can be made to be unique such that even if one system is compromised, the others are still protected.

### Design Tool

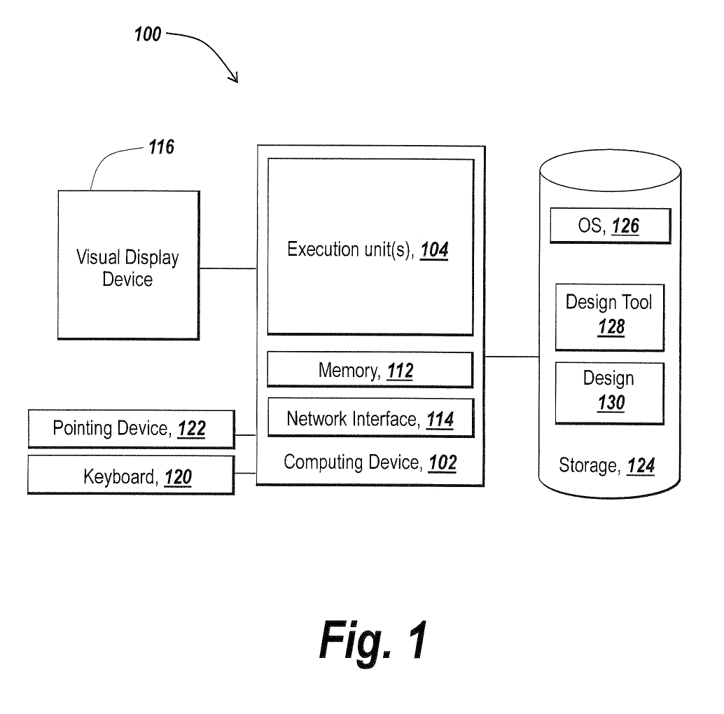

FIG. 1 is an exemplary computing device 100 suitable for practicing an exemplary embodiment. Computing device 102 may be any computer system such as a workstation, desktop computer, server, laptop, handheld computer, smartphone, or other form of computing or telecommunications device that is capable of communication and that has access to sufficient processor power and memory capacity to perform the operations described herein. Computing device 102 may include execution unit 104, memory 112, network interface 114, I/O devices, such as keyboard 120, pointing device 122, and display device 116, and storage 124. Execution unit 104 may include hardware or software based logic to execute instructions on behalf of computing device 102. The storage device 124 may be, for example, a hard-drive, CD-ROM or DVD, for storing an operating system (OS) 126 and for storing application software programs, such as design tool 128.

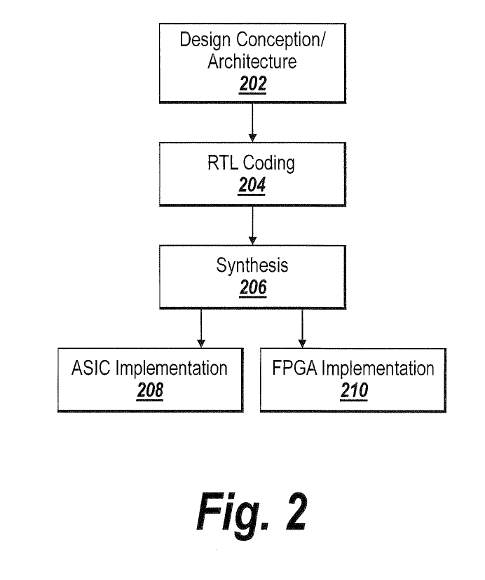

Design application or tool 128 may enable system designers (“users”) to design an electronic system, such as an integrated circuit (IC). The users may be able to design an electronic system that is protected from unauthorized access and hardware piracy. Design tool 128 may generate a design 130 of the electronic system in different levels. For example, the design 130 may describe the electronic system in computer code, such as hardware description language (HDL). HDL is a human readable language used to define hardware circuits. The design 130 may also describe the electronic system in a netlist level. An exemplary design flow using design application or tool 128 will be described below with reference to FIG. 2.

FIG. 2 is a flow chart showing exemplary steps for designing electronic systems using design application or tool 128 depicted in FIG. 1. The designers or users may conceive of the design (step 202). This conception is generally abstract, and information at this stage may be input to design application or tool 128. The conception is converted into hardware description language, such as Register-Transfer Level (RTL) code (step 204). In this step, the design intent is converted into software code that represents the system almost exactly at the clock-cycle by clock-cycle level.

The human-readable RTL code is converted into a structural netlist including Boolean primitive functions (OR, NOR, XOR, AND, and others) interconnected by wires (step 206). Design application or tool 128 interprets the RTL code and performs optimizations to convert the design as specified in the RTL code into the structural netlist. This design is now timing-optimized, in that a system built in the way specified in the structural netlist will likely operate at the target design frequency. The structural netlist is used to implement the design through either the ASSP/ASIC (step 208) or FPGA (step 210).

An exemplary embodiment provides protection of the design in the RTL code and/or post-synthesis netlist level. The exemplary embodiment may replace critical logic of the design with varying types of reconfigurable hardware in the level of the RTL code generated in step 204. Design application or tool 128 may parse the RTL code and determine which sets of original RTL can be replaced. The exemplary embodiment may also or alternatively replace critical logic of the design with varying types of reconfigurable hardware in the structural netlist level generated in step 206. Design application or tool 128 may parse the structural netlist and determine which sets of the structural netlist can be replaced.

This replacement can be done in as many places as necessary in the design to achieve security goals. This replacement can be carried out automatically by analyzing the design and factoring in timing and area requirements. It may be necessary to factor in timing and area requirements as the reconfigurable hardware consumes more area and adds logic to timing paths. For example, if a circuit is intended to operate at 250 MHz (clock period is 5 ns) and original logic has a slack (e.g. timing margin) of 0.5 ns, then during the replacement process, the delays introduced by the reconfigurable hardware logic needs to be less than 0.5 ns.

### Replacement Process

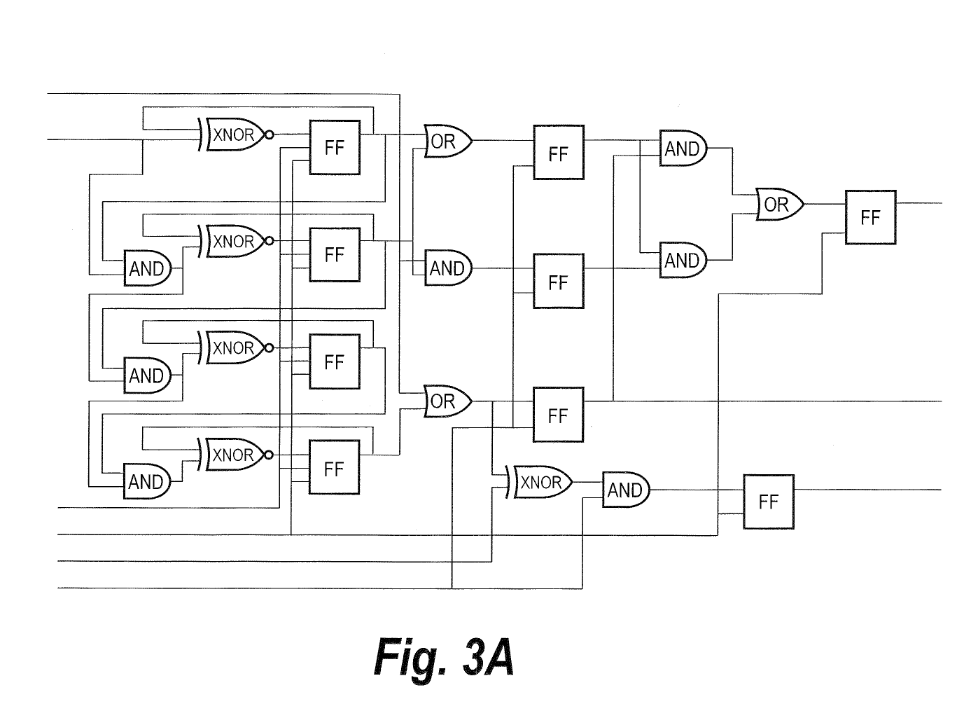

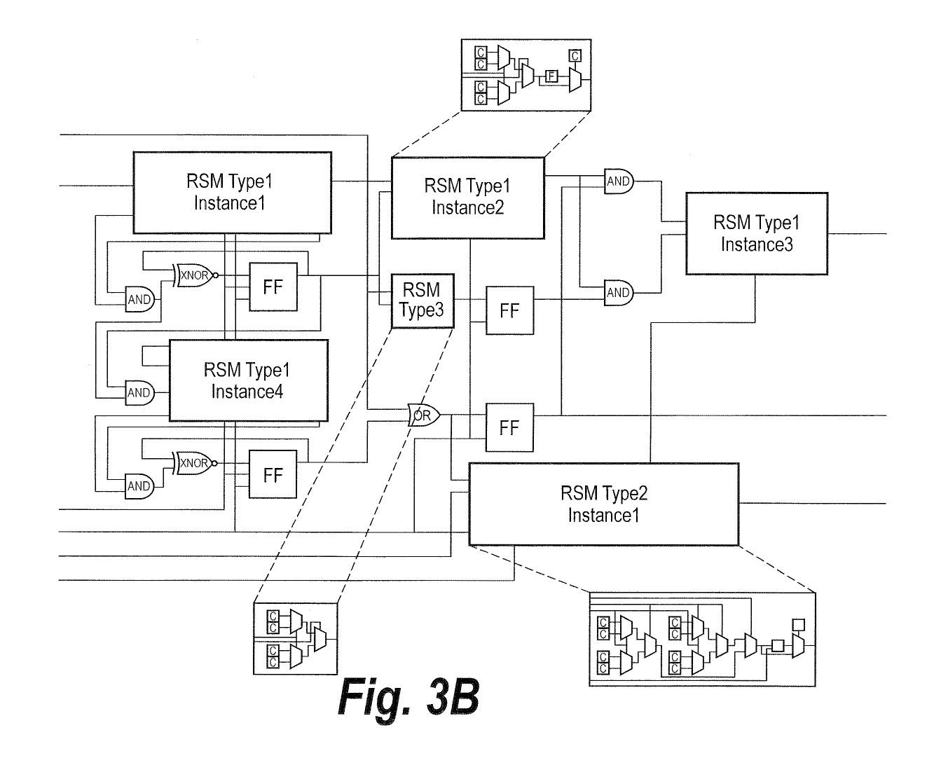

FIGS. 3A and 3B show an exemplary logic replacement in a design of an electronic system. FIG. 3A is the original design and FIG. 3B is a modified design where elements of the original design are replaced with reconfigurable hardware. The replacement may be performed in the RTL code and/or gate-level netlist. The tool 128 analyzes user's RTL/netlist design and stores it in a form that allows for modification. Using a mapping library, portions of the combinational and sequential logic are replaced with reconfigurable hardware, such as Reconfigurable Substitution Modules (RSMs). RSMs can include look-up tables (LUTs), combinational logic, and flip flops—the building blocks of programmable logic. Users may construct custom RSMs and provide their own mapping library. The ability to create custom and even random RSM increases the protection of logic against reverse-engineering of the logic.

The replacement process may be repeated multiple times to produce a unique output for each system. The unique output provides additional protection in that no two systems are alike. Therefore, hacking one system may not result in the others being compromised. This is most applicable to PLDs, where multiple RTL or netlist sources can be leveraged without significant cost penalties. For an ASIC, only one version of the replacement output may be used to manufacture the ASIC.

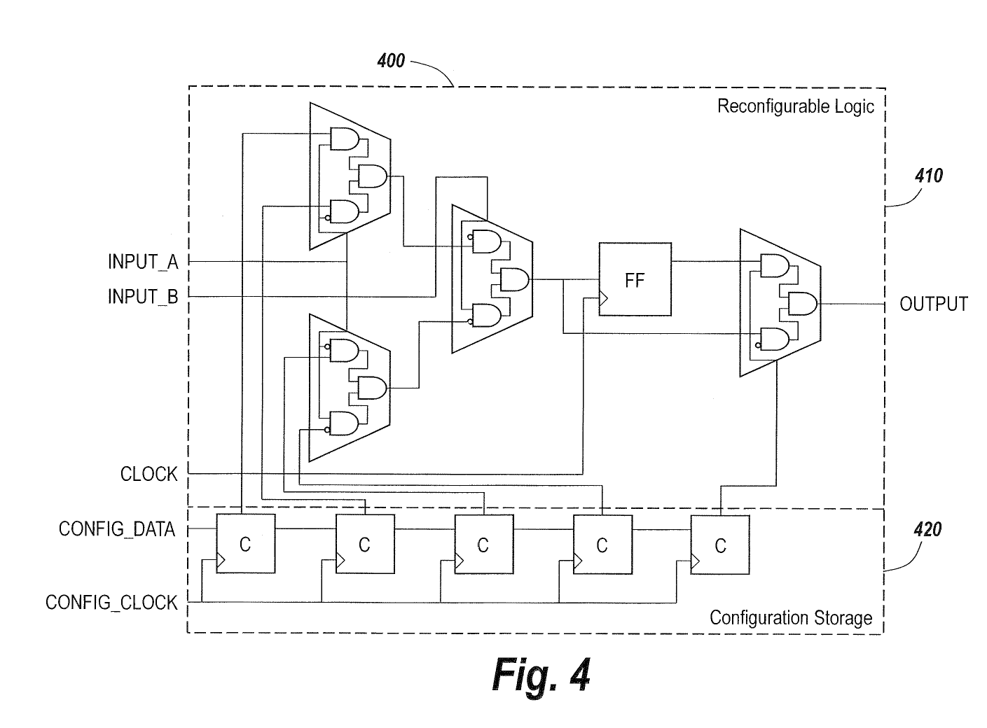

FIG. 4 shows an exemplary RSM used in the design shown in FIG. 3B. RSM 400 may include reconfigurable logic block 410 and configuration block 420. The behavior of reconfigurable module 400 is controlled by a configuration loaded in configuration block 420. Configuration block 420 contains state elements, such as registers, programmed by the configuration to configure reconfigurable logic block 410 at system run-time. In an exemplary embodiment, the state elements in configuration block 420 may be shift registers. In another embodiment, the state elements can be constructed as memory-mapped registers. When the state elements are in their default (unprogrammed) state, the function of RSM 400 is undefined.

In an exemplary embodiment, the configuration is encrypted and saved separately from RSM 400 and loaded in configuration block 420 at system run-time. The configuration may be saved on the same chip or system board. This feature of a configuration enhances the protection of RSM 400 from unauthorized access and hardware piracy. One of ordinary skill in the art will appreciate that RSM 400 is one example and other embodiments may include more complex logic functions, or programmable state machine logic.

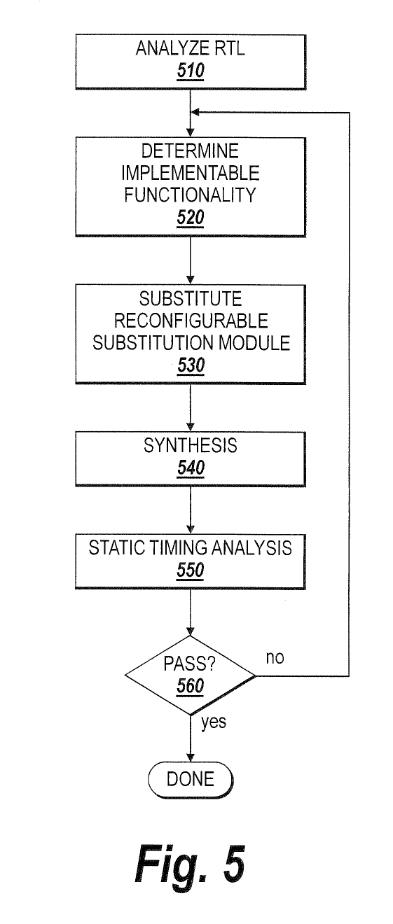

FIG. 5 is another example of an RSM with an inserted permutation block. RSM 500 includes reconfigurable logic block 510, configuration block 520 and permutation block 530. Configuration block 520 includes a set of configuration registers for holding configuration data for configuring reconfigurable logic block 510. The configuration registers hold a bit pattern that determines the function of reconfigurable logic block 510. Permutation block 530 includes inverters for inverting a selected number of bits of the configuration data applied from configuration block 520 to reconfigurable logic block 510.

Using multiple forms and types of reconfigurable logic blocks combined with the variation provided through the permutation block 530 creates a unique version of configuration data, while at the same time uniquifying the logic which makes reverse-engineering much more difficult. RSM 500 can be built to have selective inversions in the configuration data. By using the inversion, one can selectively and randomly invert the configuration bit outputs on a module-by-module level. Thus, even a sophisticated attacker who can serially shift out the plaintext configuration bits may not be able to decipher them. The only way to decipher the configuration data is to probe each and every input to the reconfigurable modules in the design, which is prohibitively difficult.

### RTL Replacement Process

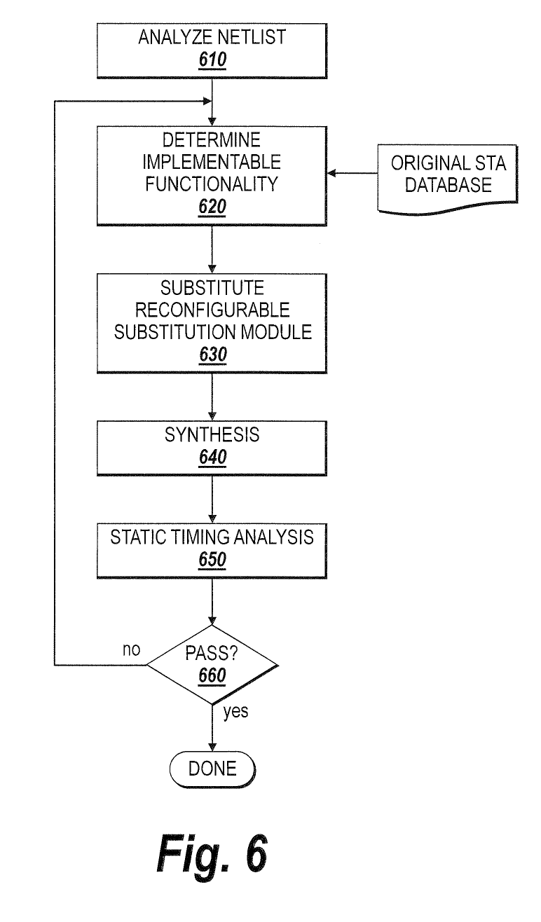

FIG. 6 is a flowchart describing the replacement process when replacement is carried out in Register-Transfer Level (RTL) code. The process begins with analysis of the RTL code (step 610). This process involves a localized synthesis operation to determine candidates for replacement (step 620). A piece of RTL code is a candidate for replacement if the primitive gates can fit in one of the possible RSM types. This process may be performed locally because a global synthesis operation may result in gates and inversions being combined in ways that are not obviously equivalent to the RTL code. A predefined or user-defined mapping file is used to select primitive candidates and one or more corresponding RSM types. An exemplary mapping may be:

| | | |
|---|---|---|
| Primitive: AND | maps to | RSM: LUT2 or LUT3 or LUT4 |
| Primitive: AND + DFF | maps to | RSM: LUT2DFF or LUT3DFF or |
| | | LUT4DFF |

The RTL code is searched for candidate primitives and a specified subset of candidates is replaced that meet timing constraints. Once candidates are selected, the candidate logic is removed, and replaced with a suitable RSM. This replacement process involves disconnecting signals, removing candidate logic instances, inserting RSM instances and reconnecting previously disconnected signals (step 630). At this point, the access mechanism is also inserted and connected to the RSMs so that they can be loaded with the proper functional configurations. Next, logic synthesis is performed (step 640).

Setting constraints helps avoid spurious timing errors caused by configurations. For example, if the RSM includes both a combinational and sequential path to its output, the appropriate configuration, which defines which of those two paths will be used under mission operation should be defined in the constraint file. Otherwise if the original candidate logic is purely combination and it is replaced with an RSM that also includes a DFF (sequential circuit) and if the synthesis tool achieves register to register timing using the RSM DFF, the combination path that includes additional combination logic elements that introduce additional propagation delay may not meet the specified timing requirements. The following code comparison shows how input RTL can be modified to replace a state machine with an RSM:

Input RTL

```
module foo(
  input wire clk;
  input wire reset;
  input wire input_a;
  input wire input_b;
  input reg [15:0] input_c;
  output reg [3:0] code);
assign sig_x = input_a | input_b;
assign sig_y = input_c & 16'haaaa;
always @(posedge clk)
begin
  if(reset == 1 )
    output_reg <= 4'h0;
  else
  begin
    if(sig_x == 1 && sig_y = 16'h0000)
      output_reg <= 4'h1;
    else
      output_reg <= 4'hF;
  end
end
endmodule;
```

Output RTL

```
module foo(
  input wire clk;
  input wire reset;
  input wire input_a;
  input wire input_b;
  input reg [15:0] input_c;
  output reg [3:0] code);
assign sig_x = input_a | input_b;
assign sig_y = input_c & 16'haaaa;
rsm srb0(
      .in0(clk),
      .in1(reset),
      .in2(sig_x),
      .in3(sig_y),
      .out0(code),
      .cfg_in( ),
      .cfg_out( ),
      .cfg_clk( ),
      .cfg_up( ),
      .cfg_cap( ));
Endmodule
```

### Netlist Replacement Process

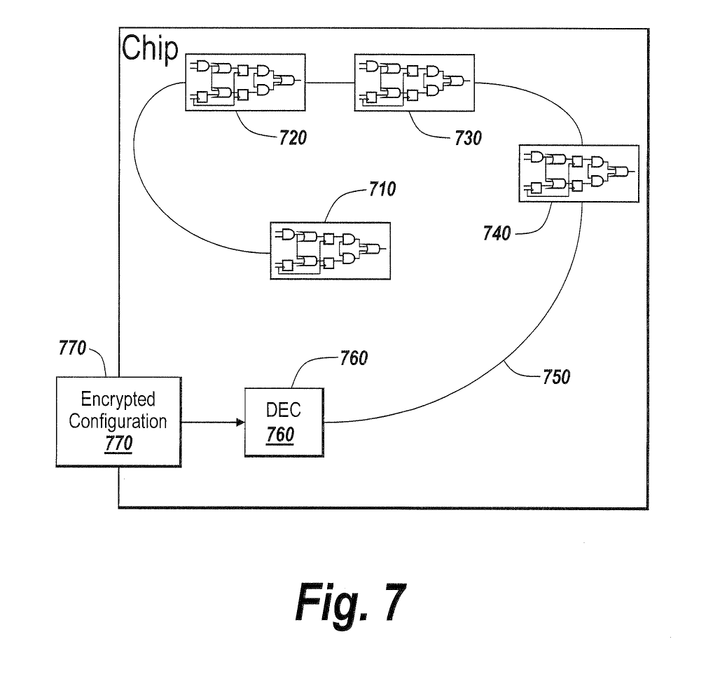

FIG. 7 is a flowchart describing the replacement process when replacement is carried out in a structural netlist level. The process of substituting reconfigurable modules for functional logic is slightly different when performed on a post-synthesis netlist. The difference is because the system on which the replacement is being performed has ostensibly already been synthesized and has already passed Static Timing Analysis (STA). The resulting netlist is a series of primitive functions. Analysis of such a system is, therefore, somewhat easier although care must be taken to avoid introducing timing conflicts.

First, the netlist is analyzed (step 710) to determine candidates for replacement (step 720). Since STA has already been performed on the netlist, the original STA database of marginal timing paths (step 760) can be used to avoid replacing logic that is part of a critical timing path. The candidate structural logic is then removed and replaced by a structurally defined RSM (step 730). At that point, Static Timing Analysis can again be run to verify that the system still runs at the target clock frequency (step 740). If the system fails this test (step 750), the process can begin again, though RSMs with passing timing characteristics need not be replaced.

### Access Mechanism

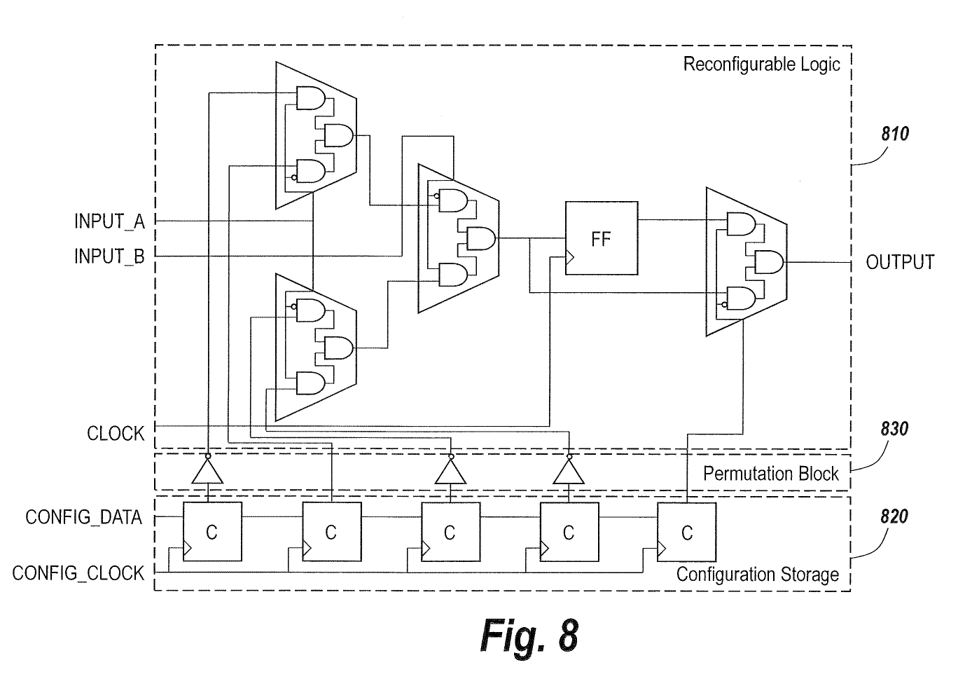

FIG. 8 is an example of an access mechanism for loading configurations into reconfigurable substitution modules (RSMs). The access mechanism connects all the RSMs on the chip 800. The access mechanism can be a parallel or serial interface that facilitates the loading of configurations into the RSMs. In an exemplary embodiment, a plurality of RSMs 810-840 are connected in a serial chain 850 to a decryption block 860. The decryption block 860 loads a data set, either serially or in parallel, from a configuration data storage device 870. The configuration data storage device 870 may be a non-volatile memory device located either on the chip 800 or on the system board. The data set stored in the configuration data storage device 870 is encrypted with an encryption algorithm. The encrypted data set is decrypted in the decryption block 860 and loaded in the RSMs via the access mechanism.

In the exemplary embodiment, an access mechanism involves an encrypted configuration data set decrypted by decryption block 860 and distributed via a daisy-chained access mechanism. The access mechanism of the exemplary embodiment is resistant to attack by invasive means, such as disassembly of the system or chip. Moreover, in the event that a system or chip is compromised, the effect is limited to the particular system or chip that is attacked. That is, although a system or chip is attacked, it is limited to the attacked system or chip and does not provide useful information on other systems or chips. One of ordinary skill in the art will appreciate that the daisy-chained access mechanism is one example and other embodiment may employ a different type of the access mechanism, such as a direct “star”-like topology.

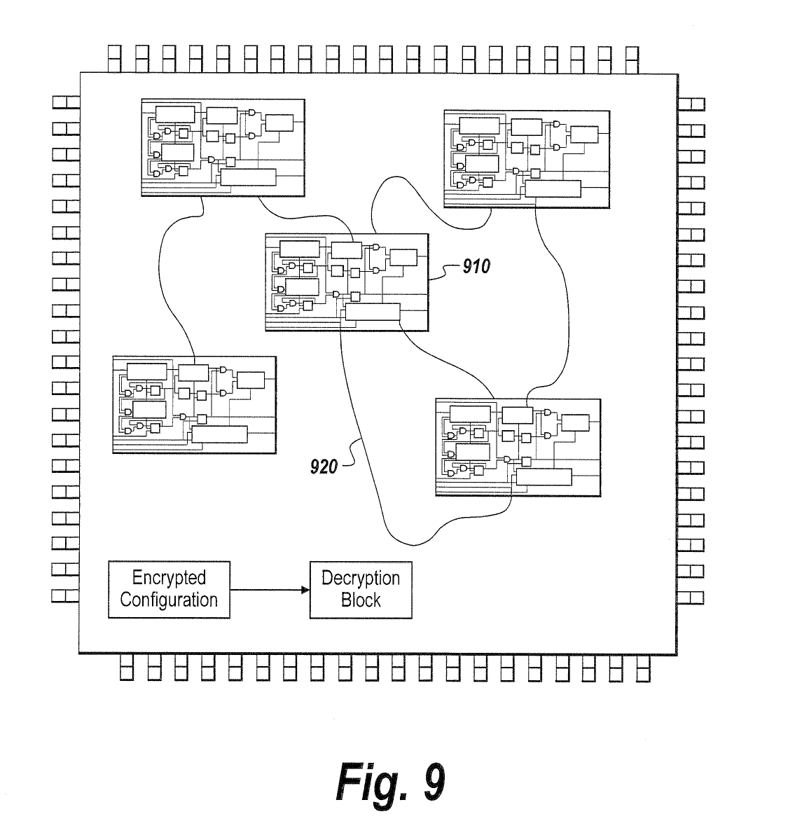

FIG. 9 is one embodiment of an obfuscated, order-dependent access mechanism. This embodiment provides another way to protect the configuration bits. The embodiment may place reconfigurable wrapper 910 inside the access mechanism. Reconfigurable wrapper 910 is placed in the way of the normal configuration path. It is controlled separately via path 920 from the decryption block to control the order of RSMs that configuration data is loaded. Reconfigurable wrapper 910 is described in more detail in U.S. Pat. No. 7,058,918 B2, the content of which is incorporated by reference. This access mechanism imposes an order dependency in the configuration process. The order dependency makes determination of the correct configuration data difficult, even if the attacker has access to the individual plaintext configurations.

### Fixing/Repairing Logic Defects

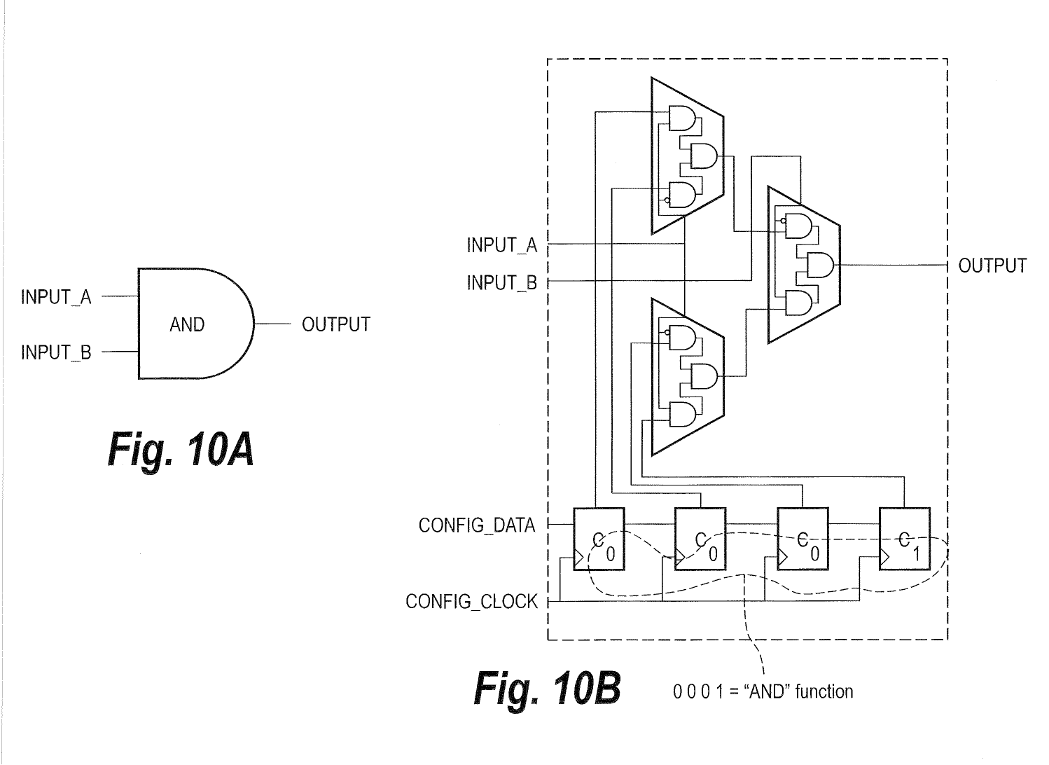

FIGS. 10A and 10B show one embodiment of an RSM used to fix a logic error. In general, the RSM structures can be programmed to perform different combinational and sequential logic functions. This intrinsic programmable and flexible characteristic is what makes them useful in hiding the original logic function. Apart from the security benefits, the RSM logic inserted into the design may have substantial benefit in providing a possible means to fix logic problems discovered after chip fabrication during the pre-deployment testing phase. This benefit applies to ASICs and ASSPs.

For example, the original design includes a 2 input AND gate, as depicted in FIG. 10A, and replaced by an RSM that contains a two input look-up-table (LUT) as shown in FIG. 10B. The LUT has four configuration registers and therefore sixteen different functions. When the configuration register is programmed with the value 0001, it may replicate the original AND function. When the user discovers a logic bug that requires this AND gate be changed to an NAND gate. With the RSM in place such a fix can be implemented by simply changing the configuration data to 1110. Otherwise, the ASIC or ASSP mask set must change to fix this error.

Exemplary embodiments are described above. It is, however, expressly noted that these exemplary embodiments are not limiting, but rather the intention is that additions and modifications to what is expressly described herein also are included within the scope of the present implementation. Moreover, it is to be understood that the features of the various embodiments described herein are not mutually exclusive and can exist in various combinations and permutations, even if such combinations or permutations are not made express herein, without departing from the spirit and scope of the present implementation.

Since certain changes may be made without departing from the scope of the present implementation, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present implementation and that the illustrations contained herein are singular examples of a multitude of possible depictions of the present implementation.

What is claimed as new and desired to be protected by Letters Patent of the United States is:

1. A method of designing an electronic system protected from unauthorized access and hardware piracy, the method comprising:
describing the electronic system in a first design;
replacing a portion of the electronic system with a reconfigurable module to generate a second design, the reconfigurable module including a reconfigurable logic block and a configuration block for storing configuration data;
encrypting the configuration data; and
saving the encrypted configuration data separately from the reconfigurable module,
wherein the reconfigurable logic block is configured to correspond to the portion of the electronic system in the first design when the configuration data is loaded in the configuration block.

2. The method of claim 1, wherein the electronic system comprises an integrated circuit (IC).

3. The method of claim 1, wherein the second design is described in a Register-Transfer Level (RTL) code level.

4. The method of claim 1, wherein the second design is described in a netlist level.

5. The method of claim 1, wherein the portion of the electronic system is replaced with a Programmable Logic Devices (PLD) that is configured to correspond to the portion of the electronic system when the configuration data is loaded in the configuration block.

6. The method of claim 1, wherein the encrypted configuration data is decrypted before the configuration data is loaded in the configuration block.

7. The method of claim 1, wherein the configuration data is loaded in the configuration block serially.

8. The method of claim 1, wherein the configuration data is loaded in the configuration block in parallel.

9. The method of claim 1, wherein the configuration data is stored in the electronic system.

10. The method of claim 1, wherein the configuration data is stored in a circuit board that includes the electronic system.

11. The method of claim 1, further comprising:
replacing a second portion of the electronic system with a second reconfigurable module to generate a third design, the second reconfigurable module including a second reconfigurable logic block and a second configuration block for storing a second configuration data;
encrypting the second configuration data; and
saving the encrypted configuration data separately from the second reconfigurable module,
wherein the second reconfigurable logic block is configured to correspond to the second portion of the electronic system in the first design when the second configuration data is loaded in the second configuration block.

12. The method of claim 1, further comprising:
placing a wrapper in a path for loading the first configuration data and the second configuration data in the first reconfigurable module and the second reconfigurable module, wherein the wrapper determines an order of the first reconfigurable module and the second reconfigurable module for loading the first configuration data and the second configuration data.

13. The method of claim 1, wherein when the configuration data is loaded from the configuration block into the reconfigurable logic block, one or more bits of the configuration data are inverted.

14. The method of claim 13, wherein the one or more bits of the configuration data that are inverted are randomly selected.

15. The method of claim 1, wherein a different configuration data is loaded in the configuration block to fix a logic bug after the electronic system is fabricated.

16. An electronic system protected from unauthorized access and hardware piracy, the system comprising:
a reconfigurable module including a reconfigurable logic block and a configuration block for storing configuration data, wherein the reconfigurable logic block is configured to correspond to a portion of the electronic system when the configuration data is loaded in the configuration block; and
a memory device saving the configuration data separately from the reconfigurable module, wherein the configuration data is encrypted and saved in the memory device.

17. The electronic system of claim 16, wherein the electronic system comprises an integrated circuit (IC).

18. The electronic system of claim 17, wherein the memory device is included in the IC.

19. The electronic system of claim 17, wherein the memory device is included in a circuit board including the IC.

20. The electronic system of claim 16, wherein the reconfigurable module comprises a Programmable Logic Devices (PLD) that is configured to correspond to the portion of the electronic system when the configuration data is loaded in the configuration block.

21. The electronic system of claim 16, further comprising:
a decryption block decrypting the encrypted configuration data before the configuration data is loaded in the configuration block.

22. The electronic system of claim 16, further comprising:
a second reconfigurable module including a second reconfigurable logic block and a second configuration block for storing a second configuration data, wherein the second reconfigurable logic block is configured to correspond to a second portion of the electronic system when the second configuration data is loaded in the second configuration block;

23. The electronic system of claim 22, wherein the second configuration data is encrypted and saved in the memory device.

24. The electronic system of claim 16, further comprising:
a path for loading the first configuration data and the second configuration data in the first reconfigurable module and the second reconfigurable module; and
a wrapper located in the path, wherein the wrapper determines an order of the first reconfigurable module and the second reconfigurable module for loading the first configuration data and the second configuration data.

25. The electronic system of claim 16, further comprising:
a permutation block for inverting one or more bits of the configuration data when the configuration data is loaded from the configuration block into the reconfigurable logic block.

26. The electronic system of claim 16, wherein a different configuration data is loaded in the configuration block to fix a logic bug after the electronic system is fabricated.

27. An apparatus for designing an electronic system protected from unauthorized access and hardware piracy, the apparatus comprising:
a storage device storing a first design of the electronic system; and
a processor configured to:
replace a portion of the electronic system with a reconfigurable module to generate a second design, the reconfigurable module including a reconfigurable logic block and a configuration block for storing configuration data;
encrypt the configuration data; and
saving the encrypted configuration data separately from the reconfigurable module,
wherein the reconfigurable logic block is configured to correspond to the portion of the electronic system in the first design when the configuration data is loaded in the configuration block.

28. The apparatus of claim 27, wherein the electronic system comprises an integrated circuit (IC).

29. The apparatus of claim 27, wherein the processor is configured to describe the second design in a Register-Transfer Level (RTL) code level.

30. The apparatus of claim 27, wherein the processor is configured to describe the second design in a netlist level.

31. The apparatus of claim 27, wherein the portion of the electronic system is replaced with a Programmable Logic Devices (PLD) that is configured to correspond to the portion of the electronic system when the configuration data is loaded in the configuration block.

32. The apparatus of claim 27, wherein the encrypted configuration data is decrypted before the configuration data is loaded in the configuration block.

33. The apparatus of claim 27, wherein the configuration data is loaded in the configuration block serially.

34. The apparatus of claim 27, wherein the configuration data is loaded in a decryption block in parallel.

35. The apparatus of claim 27, wherein the configuration data is stored in the electronic system.

36. The apparatus of claim 27, wherein the configuration data is stored in a circuit board that includes the electronic system.

37. The apparatus of claim 27, wherein the process is configured to:
replace a second portion of the electronic system with a second reconfigurable module to generate a third design, the second reconfigurable module including a second reconfigurable logic block and a second configuration block for storing a second configuration data;
encrypt the second configuration data; and
save the encrypted configuration data separately from the second reconfigurable module,
wherein the second reconfigurable logic block is configured to correspond to the second portion of the electronic system in the first design when the second configuration data is loaded in the second configuration block.

38. The apparatus of claim 27, wherein the process is configured to:
place a wrapper in a path for loading the first configuration data and the second configuration data in the first reconfigurable module and the second reconfigurable module, wherein the wrapper determines an order of the first reconfigurable module and the second reconfigurable module for loading the first configuration data and the second configuration data.

39. The apparatus of claim 27, wherein the process is configured to invert one or more bits of the configuration data when the configuration data is loaded from the configuration block into the reconfigurable logic block.

40. The apparatus of claim 39, wherein the one or more bits of the configuration data that are inverted are randomly selected.

41. The apparatus of claim 27, wherein a different configuration data is loaded in the configuration block to fix a logic bug after the electronic system is fabricated.
